(19) United States
(12) Patent Application Publication
(10) Pub. No.: US 2021/0378215 A1
(43) Pub. Date: Dec. 9, 2021

(54) AUTOMATED DEVICE FOR THE TARGETED SPRAYING OF ACTIVE MATERIAL

(71) Applicant: AB7 INNOVATION, Deyme (FR)

(72) Inventors: René CHELLE, Deyme (FR); Arnaud VILBERT, Baziege (FR); David NGUYEN, Toulouse (FR)

(21) Appl. No.: 17/283,713

(22) PCT Filed: Oct. 8, 2019
(86) PCT No.: PCT/FR2019/000166

§ 371 Date: Apr. 8, 2021

(30) Foreign Application Priority Data
Oct. 8, 2018 (FR) 1871142

(51) Int. Cl. A01K 27/00; B05B 11/00

(52) U.S. Cl. CPC A01K 27/007; B05B 12/002; B05B 11/0037

(57) ABSTRACT

Device (1) for spraying active material comprising a case (2) fixed on a support (3), said case (2) containing a liquid solution containing at least one active material in a tank (7), said solution being ejected through an ejection orifice (4), said tank (7) being equipped with an activatable diffusion mechanism (10), which communicates with an electronic circuit (10), powered by a battery (11), the activation of which triggers spraying, characterized in that the ejection orifice (4) is connected to a tubular duct with a length of between 5 and 70 cm provided with at least one outlet orifice (5′) for offsetting the ejection of said active material in the form of fine liquid particles.

The present invention is in the field of automated diffusers of active products intended to be worn by humans and/or by an animal.

Conventionally, the treatment of the infestation of domestic animals by external parasites and other undesirable living organisms involves using one or more applications of antiparasitic products formulated in various known forms. For example, curative treatments with a concentrated solution called “spot-on” involve depositing, on the skin, a quantity of active material with a formulation that is adapted to promoting its dissolution in the sebum of the animal, which results in its diffusion over the entire body. The sebum, and to a certain extent, the sebaceous glands, also act as a tank ensuring the continuity of the product.

Devices also exist that are intended to provide preventive protection against infestations. The most common devices are, in particular, antiparasitic collars, which are generally made up of a solid matrix storing a certain quantity of active antiparasitic.

However, none of the aforementioned products works automatically. In this field, there are a variety of “connected” devices on the market that are intended for the diffusion of active materials. Generally, these devices particularly comprise a body, a tank containing the active material, a printed circuit and an electricity power supply source.

For example, with regard to diffusers that are suitable for use in an enclosed space such as a room or a bedroom, patent application US2002/19225 can be particularly cited, which discloses a diffuser for diffusing insecticide in the form of droplets comprising a liquid tank, a battery, a heating resistor in contact with a plurality of submerged wicks operating by capillary action.

Patent EP1382399 discloses a pest control method using a pressurized aerosol, for which the opening/closing of the spray head is electronically controlled, which allows a determined quantity of droplets of active principle to be sprayed into the air, intermittently over an interval of time, with the droplets having dimensions of less than 20 μm. Although it is economical in terms of energy consumption, the appliance used for implementing this method is only suitable for the treatment of an enclosed space.

Document WO95/19304 discloses a device for misting anti-insect active agents, intermittently and in a determined quantity. The liquid active material is contained in a pressurized tank provided with a detachable solenoid valve, the opening of which is controlled by a printed circuit.

Patent FR2315229 discloses a device comprising an electromechanical ultrasonic nebulizer allowing an aqueous liquid to be sprayed into the air that contains an insecticide, which also can be mixed with halogenated hydrocarbons.

Finally, international application WO2009/059373 discloses an essential oil nebulization system, made up of a plurality of dispensers, each of which comprises a detachable tank, a piezoelectric plate, the activation of which, in order to trigger the diffusion, is controlled by a single central unit. Said unit is able to communicate information such as, in particular, the temperature or the duration of the operating cycle, to the dispensers.

With regard to diffusers worn by an animal, patents U.S. Pat. Nos. 4,627,385, 8,714,113 and 5,927,233 can be particularly cited, which describe cases intended to be fixed on a collar to discourage a dog from barking. To this end, in response to the sound of barking, the diffuser is capable of delivering an electric shock via electrodes, or even sound signals, or even an olfactory signal obtained by spraying essential citronella oil stored in a tank integrated in the case. The tank is provided with a solenoid valve, the opening of which is electronically controlled.

Patent EP1551220 also describes a similar device, with a pressurized tank, capable of spraying essential citronella oil intended to irritate a dog, with a view to discouraging it from barking.

Still in the same field of application, patent EP0340278 discloses a miniaturized case containing a pressurized tank provided with a solenoid valve, the opening of which is actuated by the sound of barking, said sound being converted into an electrical signal. In operation, each triggering of the solenoid valve causes the ejection of the liquid contained in the tank, which liquid is partially vaporized, depressurized, and therefore cold, the liquid that is thus ejected comes into contact with the skin of the dog, causing a sensation of intense cold.

Nevertheless, the aforementioned automated diffusers are suitable for annoying a dog in order to dissuade it from barking, since each ejection of liquid is characterized by a loud noise. By way of an example, the measured spray noise level of a device known under the trade name “HomePet” is greater than 30 decibels.

In the field of active agent diffusers, pneumatic devices are known wherein the pressure during ejection emits a characteristic noise capable of frightening an animal. This singular noise is partly due to the pressure difference between the outlet and the interior of the pressurized vessel.

Patent application US2017/0006826A1 discloses a device for locating and topically administering drugs to animals. This device involves placing an appliance containing a treatment liquid on the back or the withers of the animal to be treated/located, by means of a harness. The treatment is administered by means of a diffuser that can be activated remotely by an operator, and is capable of treating the target areas intermittently and in a directed manner. However, no measure has been taken to reduce or alleviate the problem of noise generated by the device within this application, which is therefore silent on this subject. In addition, this application does not disclose in any way any means of combining noise reduction with spraying efficiency on targeted areas of the animal.

With regard to the antiparasitic treatment of an animal, the production of noise is unnecessary, or even undesirable, in that it must be controlled in such a way that wearing the device is not a source of stress and is easily accepted by the animal. Moreover, as these diffusers can be placed near the neck of the animal, the cloud of sprayed active agent can only cover a relatively small area located around the nozzle of the solenoid valve.

An aim of the present invention is to provide a device, for which the sound intensity in diffusing active materials is greatly reduced, intended for the target areas of the human or animal body. Preferably, the device is placed in the vicinity of the neck of a quadrupedal animal, and is capable of effectively reaching the areas of the body where infestations are most prevalent, in particular the belly, the chest, the legs and the flanks. For example, it is known that the routes of tick infestation are the legs, and more generally the lower parts of a pet.

Another aim is to provide an automated device capable of diffusing active material and of allowing the best compromise to be obtained between spraying efficiency, better targeting of the areas to be treated and a reduction in the sound intensity emitted when triggering said spraying.

It is obvious that the embodiment of the device according to the invention takes into account the technical constraints linked to miniaturization, to the stability of the active agent in the liquid, as well as its effectiveness on the targets, as well as practicality both for the animal and for its master. Indeed, wearing the device should not annoy the animal or encourage the animal to remove it.

Consequently, the aim of the present invention is a device (1) comprising a case (2) fixed on a support (3), said case (2) containing a liquid solution containing at least one active material in a tank (7), said solution being ejected through an ejection orifice (4), said tank (7) being equipped with an activatable diffusion mechanism (10), which communicates with an electronic circuit (10), powered by a battery (11), the activation of which triggers spraying of said active material, characterized in that the ejection orifice (4) is connected to a tubular duct, provided with at least one outlet orifice (5′).

An ejection orifice (4) is understood to be the orifice through which the contents of the tank, namely the active material, are ejected. The ejection orifice equally can be located on the lower or the upper face of the case.

The activatable diffusion mechanisms, intended to be integrated into the liquid diffusion device, according to the invention can be:
a nozzled solenoid valve, which particularly comprises a piston and an electromagnetic coil, which form an assembly communicating with a pressurized tank;
a heating element intended to volatilize a liquid, said element being arranged so as to heat a wick soaked in said liquid coming from a tank;
a mini pneumatic pump for creating a Venturi effect, i.e. that is capable of sending an air flow into a duct, which is perpendicular to a capillary tube immersed in a liquid, with the end of the duct opposite the pump being open.

According to the invention, the activatable diffusion mechanism is preferably the solenoid valve. According to a preferred embodiment, an electronic circuit controls the actuation of the electromagnetic coil of the solenoid valve in order to trigger the spraying.

In one of the preferred embodiments according to the invention, the device comprises a spray nozzle located at the outlet orifice.

Within the meaning of the invention, the term “spray nozzle” is used to refer to a component allowing spraying of the active material to be obtained.

According to one of the preferred embodiments of the present invention, the activatable diffusion mechanism is a solenoid valve, the spray nozzle of which is offset and is fixed to the outlet orifice (5′), at the free end of the tubular duct.

In an alternative embodiment, the spray nozzle has a diameter of between 0.2 mm and 2 mm, preferably between 0.4 mm and 1 mm, and more preferably a diameter equal to 0.6 mm or to 1 mm.

The connection between the nozzle of the solenoid valve and the tubular duct is sealed by means that are well known to a person skilled in the art, such as sealing pastes, elastomers or silicones.

According to the invention, the term tubular duct is used to refer to the pipe through which the liquid to be sprayed passes.

According to the present invention, the tubular duct can be connected to the ejection orifice by interlocking, by pressing, by snap-fastening, by threading or by any other suitable means.

According to the present invention, the tubular duct is made of thermoplastic polymer such as polypropylenes, polyethylenes, polyvinyl chlorides, copolymers of ethylene and vinyl acetate, polyamides, polyurethanes, or even of metal. The tubular duct can be flexible or rigid. In a variant, the tubular duct can be made of flexible polymer and introduced into a tubular duct acting as a guide, providing it with rigidity and flexibility, and allowing the duct to be kept in a shape that is suitable for use.

According to one embodiment, the tubular duct has a length that can range from 2 to 100 cm, preferably from 5 to 70 cm, and more preferably from 10 to 30 cm. The tubular duct according to the invention has an internal diameter ranging from 0.2 to 5 mm, preferably from 0.8 to 4 mm. The length of the tubular duct is to be adapted according to the size of the animal wearing the device and the areas to be targeted with the sprayed active material.

Advantageously, provision can be made for the tubular duct to have an accordion-like structure over at least part of its length, allowing it to lengthen and/or shorten, or even to orient itself. It is this same accordion-like structure that allows the curvature of the tubular duct. In this way, the tubular duct is thus adjustable and is optimized for the different morphologies of the subject or of the animal.

According to one embodiment, provision can be made for the tubular duct to be curved at the outlet of the ejection orifice so as to orient the direction of the jet according to the morphology of the animal. The tubular duct, when it is curved, can have an angle of curvature with respect to the baseplate of between 30° and 120°, preferably between 40° and 90°. By way of an example, when the curved tubular duct is near the thorax of the animal, it can substantially conform to the shape at this location. The curvature and the rigidity of the material allow the best possible adaptation to the morphology of the target and the treatment to be optimized.

Within the meaning of the invention, the part of the nozzle that supports the tubular duct is called a baseplate.

According to one embodiment, the tubular duct can be detachable. This has the advantage of facilitating its replacement with another, the length and/or the shape of which will be adapted to the objective to be achieved.

Surprisingly, the best results combining significant noise reduction and optimal spraying have been obtained for devices for which the length of the tubular duct varies between 13 cm and 20 cm, and which comprise a nozzle with an internal diameter of 1 mm, said nozzle then being located at the outlet orifice, located at the end of the tubular duct.

In this way, the sound intensity generated by the ejection of the liquid through the tubular duct is less than 30 decibels, preferably less than 25 decibels.

Within the meaning of the invention, the term “significant reduction in noise” means a reduction that is at least equivalent to 30% compared with the device without a tubular duct.

According to one embodiment, the active material is selected from an insecticide, a repellent, an odoriferous agent, a cosmetic hair care agent, an anti-itch agent, a painkiller, or the mixtures thereof.

The insecticides and repellents of the present invention are known to a person skilled in the art, they are conventionally used to fight against the aforementioned harmful organisms. For example, the insecticides and repellents are selected, in particular, from the group formed by pyrethrinoids, pyrethrins and the derivatives thereof, carbamates, formamidines, carboxylic esters, N,N-diethyl-3-methylbenzamide (DEET), phenylpyrazoles, organophosphorus compounds, organohalogen compounds, neonicotinoids, avermectins and the derivatives thereof, spinosyns, essential oils and the constituents thereof (examples: terpenes and the derivatives thereof (alcohols, esters, aldehydes), sesquiterpenes and the derivatives thereof (alcohols, esters, aldehydes)).

Within the meaning of the invention, the targeted harmful organisms are essentially made up of ectoparasites such as, for example, fleas, ticks, lice and bedbugs. However, other harmful organisms also can be targeted, namely flying insects such as mosquitoes, sandflies, flies or even crawling insects, as well as mites.

The odoriferous agent can be of natural or synthetic origin, and is selected from perfumes, essential oils and the constituents thereof, and can be used to limit or mask the body odors of animals.

The anti-itch agent can be an essential oil such as lavandin, peppermint essential oil, lemon eucalyptus essential oil or thyme essential oil, a vegetable oil such as argan oil, canola oil or borage vegetable oil, a fatty alcohol, an ester, a fatty acid and its esters such as omegas 3, 6 and 9, vitamins such as vitamin PP, B3 or the mixtures thereof.

The cosmetic hair care agent can be a fatty substance such as alcohols, esters, vegetable oils, glycerides, essential fatty acids such as omega 3, 6, 9, for the shine of the hair or ceramides, or vitamins B5, panthenol, marshmallow root extract.

The painkiller can be an essential oil or components of essential oils, monoterpene alcohols, monoterpene aldehydes, monoterpene esters or the mixtures thereof. By way of a non-limiting example, the painkillers can be peppermint essential oil, lemon eucalyptus essential oil, wintergreen essential oil, rosemary essential oil, menthol, or methyl salicylate.

Depending on the desired aim, within the scope of the invention, the aforementioned active materials can be used alone or in combination.

The device according to the invention can be fixed on a collar, a bracelet or a harness type support, and, by way of a non-limiting example, on all the supports that are suitable for an animal. It will be understood that the case is preferably fixed on a support, however, it can also form a single body to constitute a bracelet or a collar, for example.

According to another alternative embodiment, the tubular duct comprises at least one branch, with the part of the duct directly connected to the liquid ejection orifice being unique.

According to another alternative embodiment, the tubular duct can comprise a plurality of perforations, with each perforation being capable of ejecting the fine particles of liquid containing the active material. The perforations have an average dimension of the order of a few hundred micrometers to a few millimeters. The dimensions are adapted according to the chemical nature of the solvent (gaseous, aqueous, hydro-alcoholic, oily) and that of the active material. It is ensured that the location of the perforations that are made on the tubular duct substantially coincide with the areas of infestation to be protected.

According to another alternative embodiment, at least part of the support formed by a bracelet, a collar or a harness is formed by the tubular duct on which perforations are made for forming the outlet orifices. In such a case, the free end of the tubular duct can be plugged. Advantageously, by virtue of this embodiment, it is ensured that the outlet orifices are located on the areas of interest so as to increase the efficacy of application of the treatment.

Similarly, the device according to the invention, which has a specific structure, is suitable for being fixed to a wrist bracelet worn by a person. In such a case, the active material will be an insect repellant or an insecticide.

In a known manner, the active materials are formulated in an appropriate solvent. Examples of usable solvents include, in particular, aromatic or aliphatic hydrocarbons such as vegetable oils, halogenated hydrocarbons, aromatic or aliphatic alcohols, esters, ethers and ketones, water.

Formulation adjuvants, well known in the field, such as stabilizers, surfactants, synergizing agents, antimicrobial agents also can be added, for example.

It is understood that the case of the device according to the invention comprises a tank, in which the active material in solution, formulated in a manner known to a person skilled in the art, will be found.

In the case of a nozzled solenoid valve, the liquid tank containing the active material is pressurized, and the active material is dispersed in a propellant gas type solvent. In the tank, the liquid represents 10 to 20% by weight, relative to the total weight.

In a known manner, it is possible to use propellant gas such as, for example, liquefied petroleum gas, halogenated hydrocarbons, dimethyl ether, compressed carbon dioxide, compressed gaseous nitrogen, compressed fluorinated gases such as trans-1, 3,3,3-tetrafluoroprop-1-ene. Similarly, the use of alkane-type depressant gas, in particular pentane, is not excluded. In a preferred embodiment, the propellant gas used according to the present invention is trans-1,3,3,3-tetrafluoroprop-1-ene.

According to an alternative embodiment, the case further comprises a manual control mechanism, which communicates with the electronic circuit in order to activate the diffusion mechanism, as well as a valve intended to refill the tank with liquid. The liquid rank can be dismantled for replacement.

According to another advantageous embodiment, suitable sensors and/or probes are integrated into the electronic circuit in order to deliver an electrical signal of determined and adjustable duration, which allows a determined quantity of liquid to be continuously and intermittently ejected over a determined time interval.

The electronic circuit comprises appropriate receivers, known per se, which communicate with transmitter devices suitable for remotely controlling the remote control, mobile telephone and similar devices for remotely controlling the diffusion mechanism. In a known manner, these devices equipped with such receivers also comprise a computation program adapted for executing the diffusion mechanism control and, consequently, for triggering the spraying. The remote control means can be selected from a radio system, a Wi-Fi system or a remote control.

In a known manner, the electronic circuit is a conventional processing device comprising an internal timer, memory registers and mathematical capacities, allowing a signal to be processed.

A further aim of the present invention is a use of the device for the repulsion and/or elimination of a harmful organism, according to which a liquid containing at least one pest control active material is continuously or intermittently sprayed onto at least one area of the body of a targeted animal or of a human subject by using a device intended to be fixed to a collar-type, harness-type or bracelet-type support, comprising a case intended to house a liquid tank, containing at least one active material, capable of being ejected through an ejection orifice, said tank also being equipped with an activatable diffusion mechanism capable of being connected to an electronic circuit, powered by a battery, capable of controlling said diffusion mechanism, the activation of which triggers spraying, characterized in that the ejection orifice is connected to a tubular duct provided with at least one outlet orifice intended for offsetting the ejection of said active material toward the areas of interest to be targeted on the body, in particular the main areas of infestation formed by the lower part, including the belly, the chest, as well as the legs, of the animal.

It is understood, within the meaning of the present application, that the structure of the device, in particular the support and the tubular duct, will be adapted, mutatis mutandis, as a function of the target, namely a human subject or an animal.

According to one embodiment of the method, the volume of sprayed liquid is between 10 and 400 μL over a time interval of 2 to 10 seconds, with the quantity of active material representing between 0.01 and 50% by weight of the sprayed liquid.

The present invention therefore relates to a device, and the use thereof, which can have the following different features.

The present invention therefore relates to a device (1) comprising a case (2) fixed on a support (3), said case (2) containing a liquid solution containing at least one active material in a tank (7), said solution being ejected through an ejection orifice (4), said tank (7) being equipped with an activatable diffusion mechanism (10), which communicates with an electronic circuit (10), powered by a battery (11), the activation of which triggers spraying of said active material, characterized in that the ejection orifice (4) is connected to a tubular duct with a length of between 5 and 70 cm provided with at least one outlet orifice (5′).

The invention relates to said device, characterized in that the tubular duct (5) has an internal diameter ranging from 0.2 to 5 mm.

The invention also relates to the preceding device, characterized in that the tubular duct (5) has an angle of curvature with respect to the baseplate of between 30° and 120°.

The invention relates to the preceding device, characterized in that the tubular duct contains an ejection nozzle with a diameter of between 0.2 mm and 2 mm at its outlet orifice (5′).

The invention relates to the preceding device, characterized in that the activatable diffusion mechanism (10) is a solenoid valve, the spray nozzle of which is offset and is fixed to the free end (5′) of the tubular duct.

The device according to the present invention is characterized in that the sound intensity generated by the ejection of the liquid through the tubular duct (5) is less than 30 decibels.

The device according to the present invention is characterized in that the electronic circuit (9) controls the actuation of the electromagnetic coil of the solenoid valve in order to trigger the spraying.

The device according to the present invention is characterized in that the tubular duct (5) has an accordion-like structure over at least part of its length.

The device according to the present invention is characterized in that the tubular duct (5) comprises a plurality of perforations.

The device according to the present invention is characterized in that the tubular duct (5) comprises at least one branch.

According to the present invention, the device is characterized in that the active material is selected from an insecticide, a repellent, an odoriferous agent, a cosmetic agent, an anti-itch agent, or the mixtures thereof.

According to the present invention, the device is characterized in that the electronic circuit (9) allows the diffusion mechanism (10) to be remotely controlled. Said device is characterized in that the remote control of the mechanism (10) is carried out by means of a remote control, a radio system, or a Wi-Fi system.

The present invention also relates to the use of the device described above for improving the spraying of active material and reducing the noise generated by the solenoid valve.

The present invention also relates to the use of the device for spraying a repellant or an insecticide.

The use of the device according to the present invention is characterized in that the active material is continuously or intermittently sprayed onto the target.

The use of the device allows the volume of sprayed liquid to be between 10 and 400 μL per jet over a time interval of 2 to 10 seconds, with the quantity of active material representing between 0.01 and 50% by weight of the sprayed liquid.

Further features and advantages will become apparent in the light of the following description of the figures.

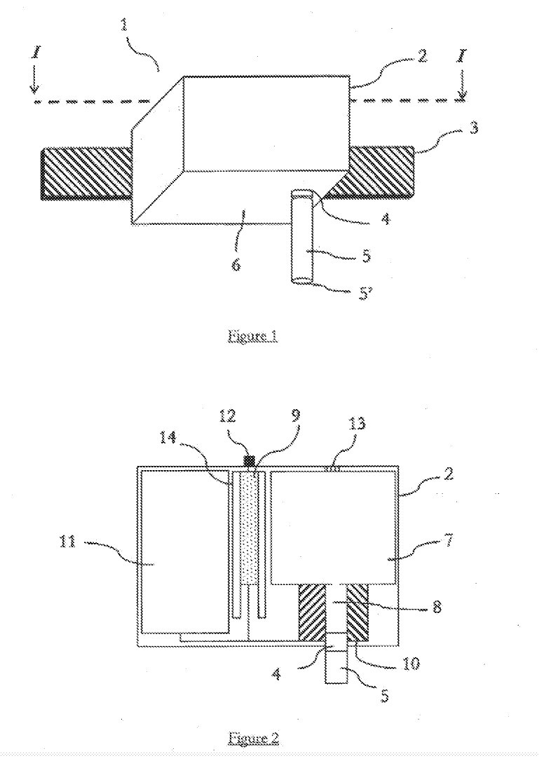

FIG. 1: is a perspective bottom view of a device according to the invention, fixed on a collar.

FIG. 2: is a simplified schematic sectional view of the device along the axis I-I of FIG. 1.

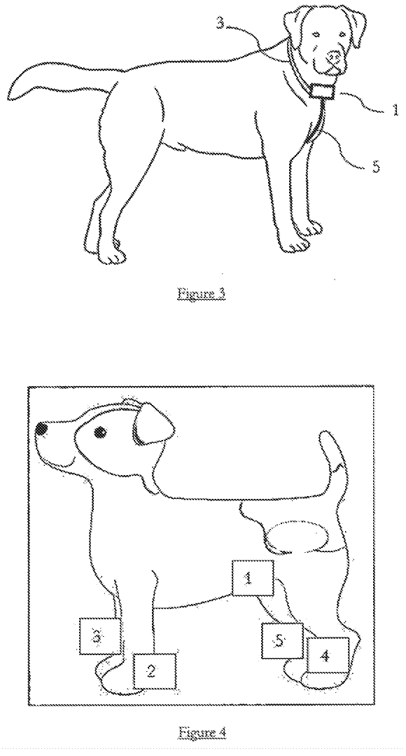

FIG. 3: is a schematic view of a dog wearing the device according to the invention.

FIG. 4: is a dog dummy on which spray tests were carried out.

FIG. 1 shows a device (1) formed by a case (2) fixed on a support (3) of the collar type intended to be worn by an animal. It can be seen, on the lower face (6) of the case (2), that the ejection orifice (4), which is a spray nozzle, is connected to a polypropylene tube (5). The nozzle (4) of the solenoid valve is connected to the tube (5), open at one of its ends (5′), the length of which is adapted according to the size of the carrier animal. In the case shown, the tube (5) is 8 cm long for an internal diameter of 2.5 mm.

FIG. 2 shows that the case (2) houses a pressurized 4 mL tank (7) containing a liquid containing an active material such as a repellant; a nozzled solenoid valve (10) equips said tank (7). The spray nozzle (4) is located at the free end of the male part of the baseplate (8). The solenoid valve (10) communicates with an electronic circuit (9), which itself is powered electrically by a battery (11), mounted interchangeably. The electronic circuit can be fixed (9) on a suitable fixing support (14). To manually activate the start-up of the solenoid valve (10), a push button (12), connected to the electronic circuit (9), can be provided on the upper part of the case (2). A liquid filling valve (13) also can be provided on the case (2).

FIG. 3 shows a dog wearing a device (1), according to the invention, fixed on its collar (3). The tube (5) is bent at the chest of the dog in order to best match the shape at this point. Clearly, when the dog is in a sitting posture, the open end (5′) of the tube (5) more easily reaches the belly area as well as the legs.

In the case whereby the device according to the invention is fixed on a harness, said harness can be placed around the hip or the thorax of an animal.

FIG. 4 shows five areas of the body of the dog on which strips of Joseph paper have been placed in order to assess the quantity of repellent deposited on each of the areas.

It can be seen that zone 1 corresponds to the abdomen, zones 2 and 3 correspond to the lower parts of the two front legs and zones 4 and 5 correspond to the lower parts of the two rear legs.

In order to understand the invention described above, the following examples are provided purely by way of a non-limiting illustration.

According to a preferred mode of operation of the device according to the invention, the device is equipped with a nozzled solenoid valve, and is fixed on a collar worn by a dog.

When an animal wears the device according to the invention, fixed on a collar-type support, each actuation of the solenoid valve by the electronic circuit causes the ejection, through the nozzle, of a quantity of liquid containing a certain dose of active material. The tubular duct has a suitable length, which allows the atomized active material to reach the lower parts of the body of an animal such as the belly or the legs. By virtue of the programming of the electronic circuit, the actuation of the solenoid valve can be carried out either automatically (for example, 2 to 5 sprays per day), or manually to cause the nozzle to open/close. Programming can involve determining the duration, frequency and quantity of liquid that is sprayed. During programming, it is also possible to select setpoint values beyond which the actuation of the solenoid valve is automatically triggered. For example, the time interval between two successive sprays can vary from 2 seconds to 5 minutes. Each spray can last between 0.5 seconds and 60 seconds. The volume of liquid ejected with each spray varies as a function of the duration of the spray, and can range from 10 μl to 200 μL.

The electronic circuit can comprise sensors or probes and transmitters. As sensors, an accelerometer can be provided that allows a warming signal to be sent in the event of excessive scratching, or conversely in the event of prolonged immobilization, which could reflect a symptomatic amorphous state following a viral infection, for example.

In the case whereby the electronic circuit comprises a transmitter that communicates with an appliance of the remote control or mobile telephone type, the actuation of the solenoid valve can be triggered remotely. In all cases, a person skilled in the art specializing in the field of electronic circuits will know how to determine the appropriate parameters and supports in order to configure the entire circuit as described by the specification of the present invention.

### Example 1: Quantification of the Distribution of a Liquid Containing a Repellent on the Lower Parts of a Dog

The spraying tests described in points 1.1 to 1.3 below were carried out on an adult dummy dog (Jack Russell), hereinafter referred to as “dummy”, on which strips of Joseph paper (25 g/m²) were placed on different parts of the body, which represents a total covered surface area of 289 cm², according to the following distribution:
a 15×9 cm strip on the stomach (zone 1);
a 3.5×11 cm strip inside each of the legs (zones 2 to 5).

After each spray, the liquid is allowed to dry for 5 min, then the quantity of essential lavender oil deposited per square centimeter of paper is weighed.

The liquid is made up of an alcoholic solution containing 5% of essential lavender oil and 90% of absolute ethanol. Trans-1,3,3,3-tetrafluoroprop-1-ene is used as the propellant gas. The tank is filled, under pressure, with all the above compounds, in order to form the “repellent liquid”.

At the same time as the gravimetric characterization tests of the essential oil deposit described above, the sound intensity generated by each of the sprays is measured using a sound level meter (Brüel & Kjær, model 2250-W).

1.1. Spray Tests Using a Device without a Tubular Duct:

A spray device known under the trade name HomePet® (model YD-4020) is provided. It is made up of a case, inside which a pressurized liquid tank is housed that is equipped with a nozzled solenoid valve. The case is also provided with a liquid filling valve. The HomePet® device is sold with a remote control, which allows spraying to be triggered at will. This device is specifically designed to discourage a dog from barking.

The tank of the HomePet® device is filled with the “repellant liquid”, then the case is fixed on a collar around the neck of the dummy, with the spray nozzle being directed downward.

Once the device is in place, spraying is triggered via the remote control. The volume of each jet is approximately 70 μl. A series of 25 sprays is carried out, then the strips of paper are collected for weighing. The experiment is repeated 3 times. The results are listed in Table 1.

TABLE 1
Measurement of the quantity of essential lavender oil deposited
on the paper and average sound intensity generated by a jet]

| | Quantity of essential lavender | Average sound intensity |
|---|---|---|
| Test | oil deposited on the paper | generated by a jet |
| number | (mg/cm²) | (dB) |
| A | 0.015 | 32 to 34 |
| B | 0.017 | |
| C | 0.012 | |

1.2 Spray Tests Using the First Variant of a Device According to the Invention:

A spraying device identical to point 1.1 is provided. The baseplate of the nozzle is connected by interlocking with a 5 cm long polypropylene tube with an internal diameter of 4 mm, with the middle of the tube being bent by an angle of approximately 45°.

The HomePet® device tank is filled with the “repellent liquid”, then the rest proceeds as in point 1.1. The experiment is repeated 3 times. The results are listed in Table 2.

TABLE 2
Measurement of the quantity of essential lavender oil deposited on
the paper by means of the tube and average sound intensity generated
by a jet, according to the first variant of the invention]

| | Quantity of essential lavender | Average sound intensity |
|---|---|---|
| Test | oil deposited on the paper | generated by a jet |
| number | (mg/cm²) | (dB) |
| D | 0.046 | <20 |
| E | 0.040 | |
| F | 0.042 | |

Compared to the results obtained with the reference device in point 1.1, it can be seen that, on the one hand, the quantity of essential lavender oil according to the first variant of the invention has been increased by 2.84 times compared to that of the HomePet® device and, on the other hand, that the sound intensity has been reduced so that its value is lower than that of the detection limit of the sound level meter.

1.3 Spray Tests Using the Second Variant of a Device According to the Invention:

A HomePet® device identical to that described in point 1.2 is provided, except that its original nozzle has been removed from its baseplate. Therefore, the baseplate of the solenoid valve is connected directly, by interlocking, to a polypropylene tube with an internal diameter of 0.8 mm for a length of 8 cm. The baseplate is connected to the orifice of the tank. The tube is bent at 90° at two-thirds of its length, i.e. substantially below the thorax. The spray nozzle, with a diameter of 0.5 mm, is then fixed to the free end of the tube.

The HomePet® device tank is filled with the “repellent liquid”, then the test proceeds as in point 1.1. The experiment is repeated 3 times. The results are listed in Table 3.

TABLE 3
Measurement of the quantity of essential lavender oil deposited on
the paper by means of the tube and average sound intensity generated
by a jet, according to the first variant of the invention]

| | Quantité d'huile essentielle de | Intensité sonore moyenne |
|---|---|---|
| | lavandin déposée sur le papier | générée par un jet |
| No essai | (mg/cm²) | (dB) |
| G | 0.160 | 20 à 22 |
| H | 0.220 | |
| I | 0.180 | |

It can be seen that, on the one hand, the quantity of essential lavender oil according to the second variant of the invention has been increased by 12.4 times compared to that of the HomePet® device of point 1.1 and, on the other hand, that the sound intensity has been reduced by 35%.

These three experiments clearly show that the addition of a tubular duct, which is orientable according to the morphology of an animal, connected to a nozzle, allows the lower parts of a dog to be targeted more effectively. When the nozzle is fixed to the free end of the tube, the quantity of essential lavender oil deposited on the areas to be treated is further increased.

Furthermore, the use of a tube allows the sound intensities generated by the jets to be significantly attenuated, unlike the devices of the prior art.

### Example 2: Tests Aimed at Determining the Influence of the Length of the Tube, the Presence or Absence of a Remote Nozzle, and the Internal Diameter of Said Nozzle, on the Noise Emitted by Each Spray

A spray device supplied by Shenzen Trainertec Electronic Co., Ltd is provided (model SP13 Remote Spray Trainer). It is made up of a case, inside which a pressurized liquid rank is housed that is equipped with a nozzled solenoid valve. The case is also provided with a liquid filling valve. The SP13 Remote Spray Trainer is sold with a remote control, which allows spraying to be triggered at will. Spraying is adjustable to two levels: Low (30-40 μL per spray) and High (70-80 μL per spray). This device is specifically designed to discourage a dog from barking. This device is called V0.

The tank of the device is filled with the “repellent liquid”, then the case is fixed on a collar placed around the neck of the dummy, with the spray nozzle being directed downward.

The liquid is made up of an alcoholic solution containing 5% of essential lavender oil and 90% of absolute ethanol. Trans-1,3,3,3-tetrafluoroprop-1-ene is used as the propellant gas. The tank is filled, under pressure, with all the above compounds, in order to form the “repellent liquid”.

Once the device is in place, the spraying is triggered via the remote control (High level). The sound intensity generated by each spray is measured using a sound level meter (Brüel & Kjær, model 2250-W) at a distance of 15 cm from the collar. A series of 6 sprays is carried out. The results are listed in Table 4.

TABLE 4

| | | Average sound | Length of the | | |
|---|---|---|---|---|---|
| | Sound | intensity generated | hose fitted on | Diameter of the | |
| | intensity generated | by one jet | the SP13 Remote | nozzle offset at | |
| Test | by one jet | (Value/standard | Spray Train Device | the end of the tube | |
| number | (dB) | deviation in dB) | (mm) | (mm) | Devices |
| 1 | 40 | 41 (1) | No hose | No nozzle | V1 |
| 2 | 42 | | | | |
| 3 | 41 | | | | |
| 4 | 42 | | | | |
| 5 | 40 | | | | |
| 6 | 40 | | | | |

The device (model SP13 Remote Spray Trainer) is modified by removing the original nozzle from its baseplate and connecting, by interlocking, the baseplate of the nozzle to a 13 cm long polypropylene tube with an internal diameter of 1 mm (supplied by Weisser Berg). The end of the hose is left free. The tube is then inserted into a metal sheath of the same length in order to be able to orient the jet (internal diameter 4 mm/external diameter 8 mm supplied by Dongguan Xinguanghong Metal & Plastic Products Co., LTD). This device is called V2.

This device is then modified as follows: a spray nozzle with an internal diameter of 0.6 mm (device V3) or 1 mm (device V4) is fixed at the end of the hose on the device V2.

The tanks of devices V2, V3 and V4 are filled with “repellent liquid”, then the cases are fixed on collars arranged around the necks of the dummies, with the spray nozzle being directed downward.

Once the devices are in place, the spraying is triggered via the remote control (High position). The sound intensity generated by each spray is measured using a sound level meter (Brüel & Kjær, model 2250-W) at a distance of 15 cm from the collars. A series of 6 sprays is carried out. The results are listed in Table 5.

TABLE 5

| | | Average sound | | Length of the | |
|---|---|---|---|---|---|
| | Sound | intensity generated | Diameter of the | hose fitted on | |
| | intensity generated | by one jet | nozzle offset at | the SP13 Remote | |
| Test | by one jet | (Value/standard | the end of the tube | Spray Train Device | |
| number | (dB) | deviation in dB) | (mm) | (mm) | Devices |
| 7 | 15 | 17 (2) | No nozzle | 130 | V2 |
| 8 | 15 | | | | |
| 9 | 17 | | | | |
| 10 | 17 | | | | |
| 11 | 19 | | | | |
| 12 | 19 | | | | |
| 13 | 31 | 33 (3) | 0.6 | 130 | V3 |
| 14 | 29 | | | | |
| 15 | 29.5 | | | | |
| 16 | 35 | | | | |
| 17 | 37 | | | | |
| 18 | 37 | | | | |
| 19 | 24 | 25 (2) | 1 | 130 | V4 |
| 20 | 24 | | | | |
| 21 | 23 | | | | |
| 22 | 27 | | | | |
| 23 | 27 | | | | |
| 24 | 26 | | | | |

The device (model SP13 Remote Spray Trainer) is modified by removing the original nozzle from its baseplate and connecting, by interlocking, the baseplate of the nozzle to a 20 cm long polypropylene tube with an internal diameter of 1 mm (supplied by Weisser Berg). The end of the hose is left free. The tube is then inserted into a metal sheath of the same length in order to be able to orient the jet (internal/external diameter 4/8 mm supplied by Dongguan Xinguanghong Metal & Plastic Products Co., LTD). This device is called V5.

This device is then modified as follows: on device V5, a spray nozzle with an internal diameter of 0.6 mm (device V6) or 1 mm (device V7) is fixed to the end of the hose. The tanks of devices V5, V6 and V7 are filled with “repellent liquid”, then the cases are fixed on collars around the necks of the dummies, with the spray tube being directed downward. Once the devices are in place, spraying is triggered via the remote control. The sound intensity generated by each spray is measured using a sound level meter (Brüel & Kjær, model 2250-W) approximately 15 cm from the collars. A series of 6 sprays is carried out. The results are listed in Table 6.

TABLE 6

| | | Average sound | | Length of the | |
|---|---|---|---|---|---|
| | Sound | intensity generated | Diameter of the | hose housed in | |
| | intensity generated | by one jet | nozzle offset at | the SP13 Remote | |
| Test | by one jet | (Value/standard | the end of the tube | Spray Train Device | |
| number | (dB) | deviation in dB) | (mm) | (mm) | Devices |
| 25 | 18 | 17 (1) | No nozzle | 200 | V5 |
| 26 | 18 | | | | |
| 27 | 18 | | | | |
| 28 | 16 | | | | |
| 29 | 17 | | | | |
| 30 | 17 | | | | |
| 31 | 34 | 34 (3) | 0.6 | 200 | V6 |
| 32 | 31.5 | | | | |
| 33 | 31 | | | | |
| 34 | 35 | | | | |
| 35 | 33 | | | | |
| 36 | 41 | | | | |
| 37 | 22 | 24 (2) | 1 | 200 | V7 |
| 38 | 23 | | | | |
| 39 | 25.5 | | | | |
| 40 | 26 | | | | |
| 41 | 27 | | | | |
| 42 | 22 | | | | |

Spraying devices V1, V2, V5, V6 and V7 are provided, the tanks of which are filled with the “repellent equid”. The cases are fixed on collars around the necks of dummies, with the spray tube being directed downward. For devices fitted with a tube, the flexible metal sheath is tilted so as to tat-et the belly part of the dummy on which a strip of Joseph paper (25 g/m²) measuring 15×9 cm is placed. The tube is bent at 90° at two-thirds of its length, i.e. substantially below the thorax.

Once the devices are in place, 25 sprays are triggered (High position). The liquid is allowed to dry for 5 min, then the quantity of essential lavender oil deposited per square centimeter of paper is weighed. Each test is repeated six times. The results are listed in Table 7.

TABLE 7

| | Average quantity of | | | |
|---|---|---|---|---|
| | essential lavender | Length of the | | |
| | oil deposited by 25 | hose fitted on | Diameter of the | |
| | sprays on the paper | the SP13 Remote | nozzle offset at | |
| Test | (Value/Standard | Spray Train Device | the end of the tube | |
| number | deviation in mg/cm²) | (mm) | (mm) | Devices |
| 43 | 0.01 (0.01) | No tube | No nozzle | V1 |
| 44 | 0.16 (0.11) | 130 | No nozzle | V2 |
| 45 | 0.27 (0.11) | 200 | No nozzle | V5 |
| 46 | 0.22 (0.06) | | 0.6 | V6 |
| 47 | 0.38 (0.10) | | 1 | V7 |

The results provided in Tables 4, 5 and 6 show that:
The addition of a tube leads to a significant attenuation of the noise; the noise values measured with devices V2, V3, V4, V5, V6 and V7 are lower than those obtained with device V1 (unmodified).
The length of the tube does not significantly influence the noise attenuation, if Tables 2 and 3 are compared.
A tube without a spray nozzle attenuates noise better than a modified tube with a nozzle (0.6 or 1 mm internal diameter).
Noise reduction is less effective with a small diameter spray nozzle (0.6 mm).

The results given in Table 7 show that:
The addition of a tube makes it possible to obtain, in all cases, effective targeting of the active material on the targeted area (belly): the quantities of active material weighed with devices V2, V3, V4, V5, V6 and V7 are greater than those obtained with device V1 (not modified).
A longer tube allows more active material to be recovered in the targeted area.
The best results are obtained with a long tube and a nozzle with a 1 mm internal diameter.

1. A device comprising a case fixed on a support, the case containing a liquid solution containing at least one active material in a tank, the solution being ejected through an ejection orifice, the tank being equipped with an activatable diffusion mechanism, which communicates with an electronic circuit, powered by a battery, the activation of which triggers spraying of the active material, wherein the ejection orifice is connected to a tubular duct with a length of between 5 and 70 cm provided with at least one outlet orifice.

2. The device according to claim 1, wherein the tubular duct has an internal diameter ranging from 0.2 to 5 mm.

3. The device according to claim 1, wherein the tubular duct has an angle of curvature with respect to a baseplate of between 30° and 120°.

4. The device according to claim 1, wherein the tubular duct contains an ejection nozzle with a diameter of between 0.2 mm and 2 mm at its outlet orifice.

5. The device according to claim 4, wherein the activatable diffusion mechanism is a solenoid valve, a spray nozzle of which is offset and is fixed to a free end of the tubular duct.

6. The device according to claim 1, wherein a sound intensity generated by the ejection of the liquid through the tubular duct is less than 30 decibels.

7. The device according to claim 5, wherein the electronic circuit controls the actuation of an electromagnetic coil of the solenoid valve in order to trigger the spraying.

8. The device according to claim 1, wherein the tubular duct has an accordion-like structure over at least part of its length.

9. The device according to claim 1, wherein the tubular duct comprises a plurality of perforations.

10. The device according to claim 1, wherein the tubular duct comprises at least one branch.

11. The device according to claim 1, wherein the active material is selected from an insecticide, a repellent, an odoriferous agent, a cosmetic agent, an anti-itch agent, or the mixtures thereof.

12. The device according to claim 1, wherein the electronic circuit allows the diffusion mechanism (10) to be remotely controlled.

13. The device according to claim 12, wherein the remote control of the diffusion mechanism is effected by means of a remote control, a radio system, or a Wi-Fi system.

14. A method for improving spraying of an active material comprising using the device according to claim 1 for spraying a volume of liquid on a target.

15. The method according to claim 14, wherein the active material is a repellant or an insecticide.

16. The method according to claim 14, wherein the active material is continuously or intermittently sprayed onto the target.

17. The method according to claim 14, wherein the volume of the liquid sprayed is from 10 to 400 μL per jet over a time interval of 2 to 10 seconds, and wherein the quantity of active material is from 0.01 to 50% by weight of the volume of liquid.
